(19) United States
(12) Patent Application Publication
(10) Pub. No.: US 2017/0225111 A1
(43) Pub. Date: Aug. 10, 2017

(54) GRAIN DRYER FILTERING APPARATUS AND METHOD

(71) Applicant: Chief Industries, Inc., Grand Island, NE (US)

(72) Inventors: Bradly Jorgenson, Gothenburg, NE (US); Nathan Fries, Boelus, NE (US); Paul Oberbrockling, Kearney, NE (US)

(73) Assignee: Chief Industries, Inc., Grand Island, NE (US)

(21) Appl. No.: 15/424,193

(22) Filed: Feb. 3, 2017

Related U.S. Application Data
(60) Provisional application No. 62/291,272, filed on Feb. 4, 2016.

(51) Int. Cl. B01D 46/00; B01D 50/00; F26B 25/00; B01D 45/16

(52) U.S. Cl. CPC B01D 46/0065; B01D 45/16; B01D 46/0047; B01D 50/002; F26B 25/007; B01D 2279/00

(57) ABSTRACT

A grain dryer filtering apparatus includes a filter positioned near the inlet of the exhaust fan of the dryer, and a nozzle positioned near a portion of the filter. The nozzle is part of a rotary head. Attached to the rotary head is a vacuum source. The grain dryer also includes a head mover attached to the nozzle. The head mover moves the nozzle over other portions of the filter to remove material captured by the filter media. A method of filtering the exhaust from a grain dryer includes placing a filter near the input of an exhaust fan, capturing material at the filter media, and removing at least a portion of the captured material from the filter as the exhaust fan operates using a vacuum.

### TECHNICAL FIELD

Various embodiments described herein relate to generally to a grain dryer filtering apparatus. More particularly, various embodiments of the disclosure relate to a grain dryer filtering apparatus that places a filter media near the inlet of the exhaust fan on a commercial grain dryer.

### BACKGROUND

Farmers all over the world grow grain. A portion of the grain may be used to feed animals. In many instances, grain is sold as a cash crop to provide income to a farming business. Some farmers have little or no livestock and are considered grain farmers. Regardless of the type of farm operation, any grain grown will have to be stored. Some farms have grain bins. The harvested grain may be stored in grain bins on the farm until a more favorable price occurs or until needed for other purposes, such as feeding to livestock. Other farmers sell their grain at harvest time. In many instances, farmers sell their crop well before harvest time. The crop or a portion of the crop can be sold in the futures market. In this way, the farmer locks in a price. Meeting the contract includes delivering the grain to another.

Farmers typically let the grain mature in the field to dry out. Grain needs to be properly dried to a particular moisture content so that it can be stored without having problems of spoilage due to moisture. If the moisture content of grain is higher than the acceptable range for each type of grain, it has a good chance of spoiling while in a grain bin. Spoilage occurs no matter what size of grain bin is used. The moisture content can be measured when in the field as well as when harvested and while in the bin of a combine. The moisture content can also be measured when the grain is contained in a truck trailer. There may be times when the farmer has to make a tough decision and has to harvest the grain before the grain moisture level is at a level where the grain will not spoil. All is not lost. The grain can be harvested and further dried to prevent spoilage due to moisture. The grain can be dried on a farm or at a much larger elevator. An elevator is a place where grain is stored and shipped to market. In many instances, an elevator is located on a rail line. Generally when corn is sold at an elevator, the moisture content is checked using a probe. For example, if a truck is used to transport grain from the farm where it is harvested, the elevator personnel will place a probe into the trailer that contains the grain. If the moisture content is too high, the price paid for the grain will be docked to account for the energy and time necessary to further dry the grain so it can be stored with less chance of spoiling as well as possible grain shrinkage.

When drying grain, warmed or hot air is passed through the grain which drives moisture out of the grain. Moisture is not the only thing that moves out of the grain. Grain dust can move out of the grain dryer as well as other parts of the grain. For example, corn includes dust and another portion commonly referred to as “bees wings”. The “bee's wings” are a thin membrane that are at the interface between an individual kernel and the corn cob. In harvested corn, there generally are a large number of “bee's wings” that are retained when removing the kernels from the corn cob in a combine machine.

In an elevator, large amounts of grain may need to be dried relatively quickly during 3 or 4 weeks of harvest. The grain needs to be dried quickly so it can be shipped. In such a commercial setting, there are dryers that can dry corn 15-20% moisture content with a throughput of nearly 13,000 bushels/hour. There are of course smaller commercial dryers as well. With such capacities, there can be a large amount of “bee's wings” that can be separated from the corn kernel and exhausted out of the commercial dryer. Elevators are typically found in smaller and larger towns where there are houses and public facilities. Excessive “bee's wings” output from an elevator handling corn have caused problems. For example, in one town a city pool had its filters clogged with bee's wings from the elevator. In other towns, the same thing has happened to air conditioning filters which draw air through coils to reject the heat in an air conditioner. Filters outside the coils can choke the amount of air that can get to the coils and fins of the outside unit of an air conditioner which makes the system much less efficient. Therefore, there is a need for a system which can remove selected materials from an elevator dryer. As an example, there is a need to at least partially remove the “bee's wings” from the exhaust of a commercial dryer for corn.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 is an elevation view of a commercial grain dryer that uses the inventive filter apparatus, according to an example embodiment.

FIG. 2 is a schematic cutaway view of a grain dryer that uses the inventive filtering apparatus, according to an example embodiment.

FIG. 3 is a schematic view of a filtering apparatus for a grain dryer, according to an example embodiment.

FIG. 4 is a front perspective blow up view of a filter and a material remover of a filtering apparatus for a grain dryer, according to an example embodiment.

FIG. 5 is a front perspective assembled view of a filter and a material remover of a filtering apparatus for a grain dryer, according to an example embodiment.

FIG. 6 is a side elevation view of the filter and the material remover along line 6-6 shown in FIG. 5, according to an example embodiment.

FIG. 7 is a rear perspective view of an assembled filter apparatus for a grain dryer, according to an example embodiment.

FIG. 8 is a view of a portion of the filtering apparatus positioned near an exhaust fan of a grain dryer, according to an example embodiment.

FIG. 9 is a flow diagram of a method of filtering in a grain dryer, according to an example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

A grain dryer filtering apparatus includes a filter positioned near the inlet of the exhaust fan of the dryer, and a nozzle positioned near a portion of the filter. The grain dryer also includes a head mover attached to the nozzle. The head mover moves the nozzle over other portions of the filter. A vacuum source fluidly coupled with the head and produces a vacuum at the nozzle while it moves over the filter. In one embodiment, the filter is a filter media. The filter is a filter media having openings therein for retaining material in the filter media before it exits the dryer. In one embodiment, the head mover rotates the nozzle. The filter is substantially circular in shape and the nozzle has a length about the same as the diameter of the circular filter. The head mover rotates the nozzle to pass the nozzle in close proximity to the filter. The vacuum source is fluidly coupled to the head. The vacuum is sufficient to remove material from the filter. Debris and other material caught in the filter can be removed from the filter by the nozzle as the head mover rotates the nozzle over the filter. In one embodiment, the head mover includes a gearbox, and the head includes a shaft. One end of the shaft is coupled to the gear box. The nozzle rotates over the filter in response to the gearbox turning the shaft. In one embodiment, the vacuum source includes a collection fan in fluid communication with the head. In one embodiment, the vacuum source also includes a cyclonic separator in fluid communication with the collection fan and the head. The collection fan and the cyclonic separator can be ducted to one another and to the head. In yet another embodiment, a return path is used to place air from the cyclonic separator in a plenum near the exhaust fan. In one embodiment, the plenum is located adjacent the filter near the exhaust opening of the dryer.

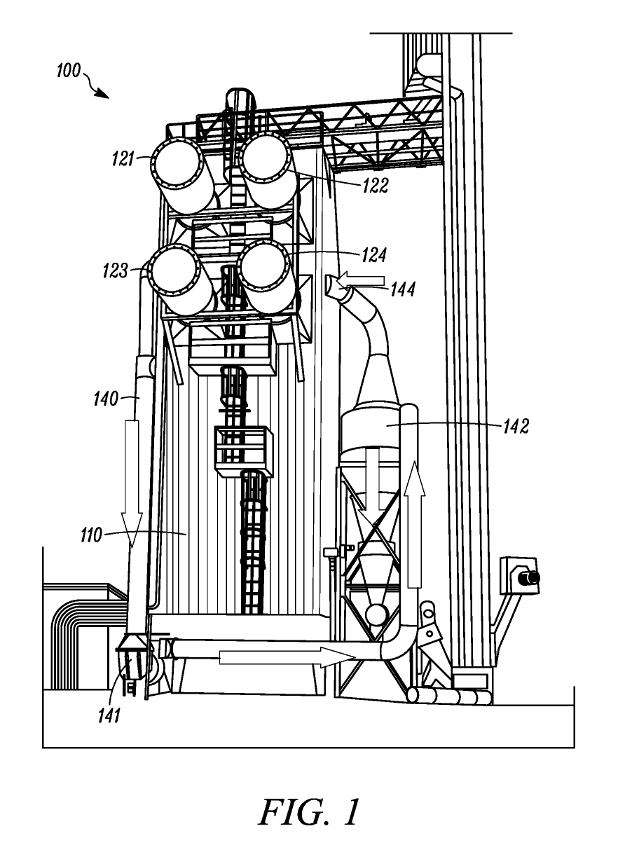

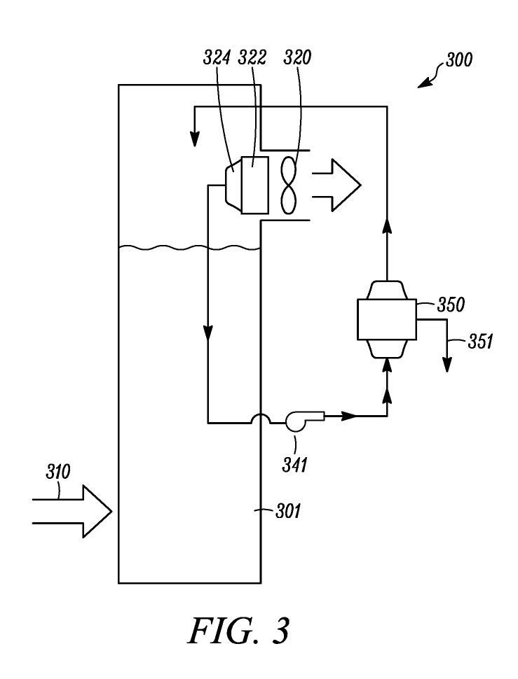

FIG. 1 is an elevation view of a commercial grain dryer 100 that uses the inventive filter apparatus 300, according to an example embodiment. The grain dryer 100 includes a grain column 110 into which wet grain or grain with a moisture content above a certain level is placed. Warmed air is circulated through the grain in the column 110 to dry the grain. The warm air is cooled as it passes through the grain. After passing through the grain, the air is discharged or exhausted to the environment through exhaust ports 121, 122, 123, and 124. FIG. 1 shows the exterior of the grain dryer 100. The grain dryer also includes a set of stairs and platforms to allow access to the exhaust ports and to the top portion of the grain dryer 100. The exhaust ports 121, 122, 123 and 124 are horizontally orientated. In some grain dryers, the exhaust ports are vertically orientated. Grain dryers can also be of varying sizes. For example some grain dryers are small, such as those found on a family farm. The grain dryer shown in FIG. 1 is a commercial version which have a variety of sizes. For example, Chief Industries of Kearney, Nebr., USA has a line of commercial grain dryers sized so that as many as 13000 bushels or more of grain can be dried per hour. The commercial grain dryer shown in FIG. 1 also includes ducting for an auxiliary air pathway 140 that removes air and material from filters (shown in FIGS. 3-7) within the grain dryer 100 and passes the air and material through a cyclonic separator 142. A collection fan or air handler 141 moves the air through the auxiliary air path 140 and produces a vacuum at or near the inlet portion, which is further detailed below. The material in the air or at least some of the material in the air is substantially removed from the air by the cyclonic separator 142. The material can be discarded or recovered and placed into an elevator or grain bin with dry grain. As shown in FIG. 1, the auxiliary pathway 140 includes an inlet 144 back into the grain dryer 100 near the exhaust ports 121, 122, 123 and 124. The grain dryer 100 also includes an exhaust plenum 111 which is the space in the grain dryer after the grain column 110 where the exhausted air goes before exiting out exhaust ports 121, 122, 123, 124. The exhaust ports 121, 122, 123, 124 are attached to the plenum.

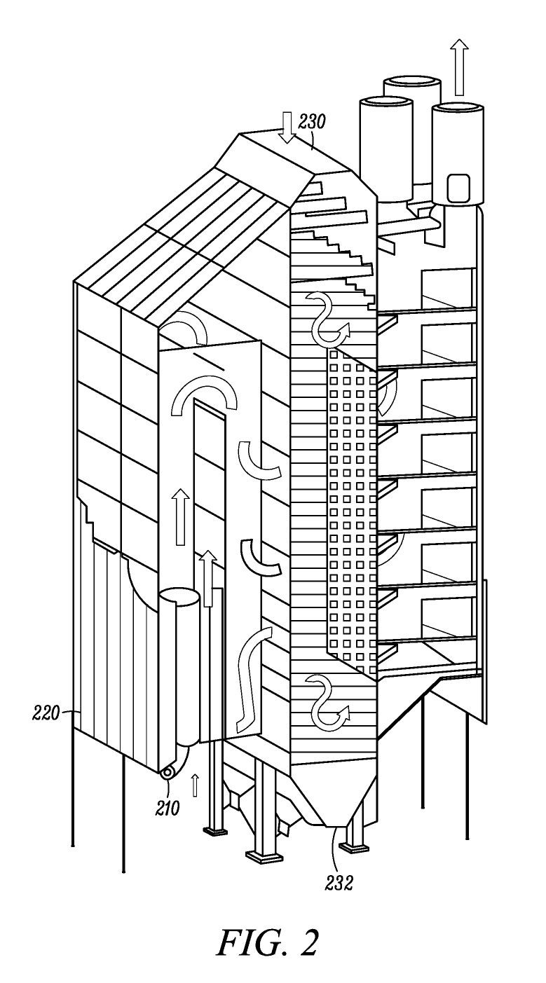

FIG. 2 is a schematic cutaway perspective view of a grain dryer 100 that uses the inventive filtering apparatus, according to an example embodiment. FIG. 2 details the interior of the grain dryer 100. The grain dryer 100 includes burners 210 which burn fuel and produce heat to heat the air that passes through the wet grain or high moisture content grain. In the embodiment shown, the burners 210 are fully modulating gas burners 210 that include gas trains. The grain dryer 100 also includes combustion chamber 220. The grain dryer 100 includes an inlet 230 for receiving the wet or high moisture content grain. The grain is fed via gravity to an outlet 232. A grain column 231 is located between the inlet 230 and the outlet 232. As the grain passes from the inlet 230 to the outlet 232, heated air passes through the grain in column 231. Heated air is passed through ducts in the grain column 231. The air picks up moisture and cools as it passes through the grain. The air is removed from the grain dryer by the exhaust fans 221, 222, 223. Cool air is also passed through the grain column 231 near the discharge. As the air is passed through the grain in the grain column 231, the air picks up materials. One common grain that is dried is corn. Corn includes dust as well as a small thin portion that is formed between the corn cob and the kernel. These thin portions are referred to by several names, including bee's wings. The name bee's wings is used because the material is small and thin much like a bee's wing.

FIG. 3 is a schematic view of a filtering apparatus 300 for a grain dryer 100, according to an example embodiment. Warm air or heated air 310 is input to the grain dryer 100. The heated air dries the grain or, more accurately, reduces the moisture content of the grain in the bin until it is at an acceptable level where the grain 301 will not spoil due to excessive moisture. After the air is passed through the grain, it is passed through an exhaust port 320. A filter 322 covers the exhaust port. The filter 322 captures material which is in the air that has passed through the grain. A material remover 324 is passed over the filter 322 to remove the captured material from the filter 322. This allows the filter 322 to capture more material. If the material is not removed, the filter is more likely to restrict air flow through the system. The material remover is fluidly coupled to a fan or collection fan 341. The collection fan 341 produces a vacuum at the portion of the material remover 324 that is adjacent the filter 322. A substantial portion of the material is removed from the filter and carried through duct work to the collection fan and then to a cyclone separator 350. The cyclone separator 350 removes material from the air. The material removal is depicted by the arrow 351. Clean air is output from the separator 350 and input into the grain dryer. As shown in FIG. 3, the clean air is placed in the exhaust plenum 311 near the exhaust port 320. The clean air could be placed into the grain dryer at other spots or could be exhausted to atmosphere. The advantage of placing the clean air back into the grain dryer is that if the cyclonic separator 350 does not remove all the material, the air can be refiltered and passed through the process once again.

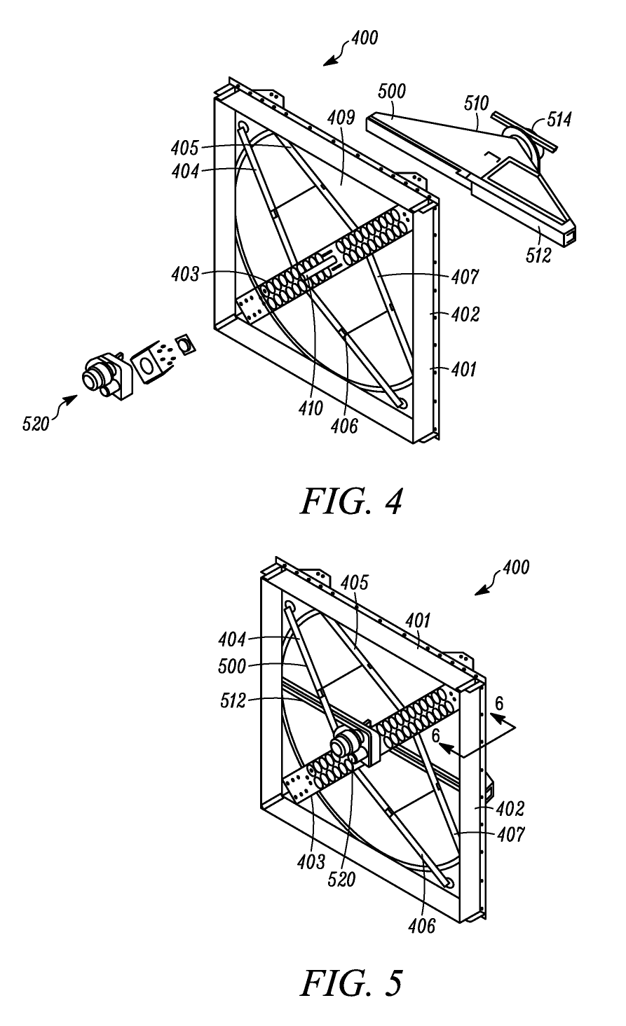

FIG. 4 is a front perspective blow up view of a filter 400 and a material remover 500 of a filtering apparatus for a grain dryer (shown in FIGS. 1-3), according to an example embodiment. FIG. 5 is a front perspective assembled view of a filter 400 and a material remover 500 of a filtering apparatus for a grain dryer, according to an example embodiment. Now referring to both FIGS. 4 and 5, the filter 400 and the material remover 500 will be described in further detail. The filter 400 includes an outer frame 401. As shown in FIGS. 4 and 5, the frame 401 is square-shaped. It should be noted that the frame 401 could also have another shape. A cross member or cross support 403 extends diagonally across the frame 401. Specifically, the cross member 403 extends from one corner to another corner of the frame 401. A series of stiffeners 404, 405, 406, 407 are attached at one end to the cross member or cross support 403 and at the other end to the frame 401 of the filter 400. The stiffeners 404, 405, 406, 407 stiffen the cross member 403. A filter media 409 is attached to the frame 401. The filter media 409 includes varying sized openings, dependent on the grain being dried, that will allow air to move through the filter media but will capture material. For example, the filter media associated with a corn grain type dryer, will have openings that capture or stop bee's wings that are released when air that has been used to dry the corn passes through the filter 400.

Attached to the cross member 403 is a shaft 410. The shaft 410 is mounted on bearings to allow rotation of the shaft 410. One end of the shaft 410 is attached to a gearmotor 520. The gearmotor 520 turns or rotates the shaft 410. On the other end of the shaft 410, the material remover 500 is fixedly attached so that when the gearmotor 520 rotates the shaft 410, the material remover 500 also rotates. The material remover 500 has a portion that is adjacent the filter media 409. The material remover 500 is located on the upwind side of the exhaust port. In other words, the material remover is within the grain dryer and within the air flow before the air leaves or passes through the exhaust port.

The material remover 500 includes a rotary head 510. The rotary head 510 is in the form of a trapezoid-shaped nozzle that includes an elongated nozzle 512 along the edge of the nozzle that is adjacent the filter 400. More specifically, the edge of the nozzle is adjacent the filter media 409 of the filter. The rotatory head 510 also has a duct end 514 which is attached to a duct. The duct end 514 is distal from the elongated nozzle 512. A source of vacuum is in fluid communication with the duct end 514. The duct end 514 of the rotary head 510 is connected to the duct by a sleeve that seals the duct end to a fixed duct while it rotates. It should be pointed out that the end need not be totally sealed. In one embodiment, the seal between the duct end 514 of the rotary head 510 and the fixed duct which produces a vacuum, is sufficient so the vacuum or negative pressure is delivered to the elongated nozzle 512. In operation, the vacuum at the elongated nozzle 512 is sufficient to remove material captured by the filter media 409. The gearmotor 520 rotates the material remover 500 so that the elongated nozzle 512 also rotates about filter 400.

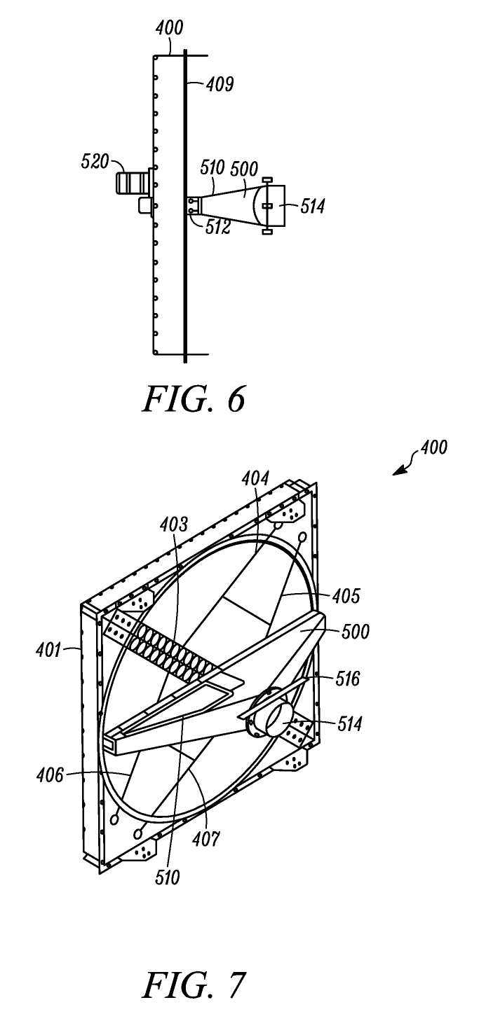

FIG. 6 is a side elevation view of the filter 400 and the material remover 500 along line 6-6 shown in FIG. 5, according to an example embodiment. The side view reveals that the material remover 500 necks down from the duct end 514 to the end that includes the elongated nozzle 512. The filter media 409 is also shown attached to the frame 401 of the filter 400. The elongated nozzle 512 or slit of the rotary head is positioned near or substantially adjacent the filter media 409 so that the vacuum produced at the elongated nozzle 512 is applied to the filter media 409 to remove material captured on top of the filter media 409. In one embodiment, the vacuum is sufficient to remove bee's wings from a grain dryer holding corn. The gearmotor 520 rotates the rotary head 510 which in turn repositions the elongated nozzle 512 over another portion of the filter media 409. Rotating the rotary head 510 a full rotation passes the material remover 500 over a circular portion of the filter media 409. Thus, material is removed from the filter media 409 and passed through the ductwork described with respect to FIG. 1 above. The filter media 409 is continually cleaned of most of the material so that the exhaust fan 320 continues to move moist air through the outlet of the grain dryer (see FIG. 3 and related discussion).

FIG. 7 is a rear perspective view of an assembled filter 400 and material remover 500 for a grain dryer, according to an example embodiment. Again, the frame 401 includes a cross member 403. A set of stiffeners is attached to the cross member 401. The stiffeners 404, 405, 406, 407 attach to the frame 401 at one end and to the cross member 403 at the other. The rear perspective view shows the material remover 500 in more detail. The duct end 514 is circular. Attached to the duct end 514 is a mount 516 or duct hanger. This allows the duct end 514 to be attached to a support within the grain dryer. The support can be attached to the grain dryer by any means. In one embodiment, the grain dryer is attached with an anti-rotation device to an inner structural portion of the grain dryer. The duct end 514 can also be supported in any position, including a substantially horizontal position and a substantially vertical position.

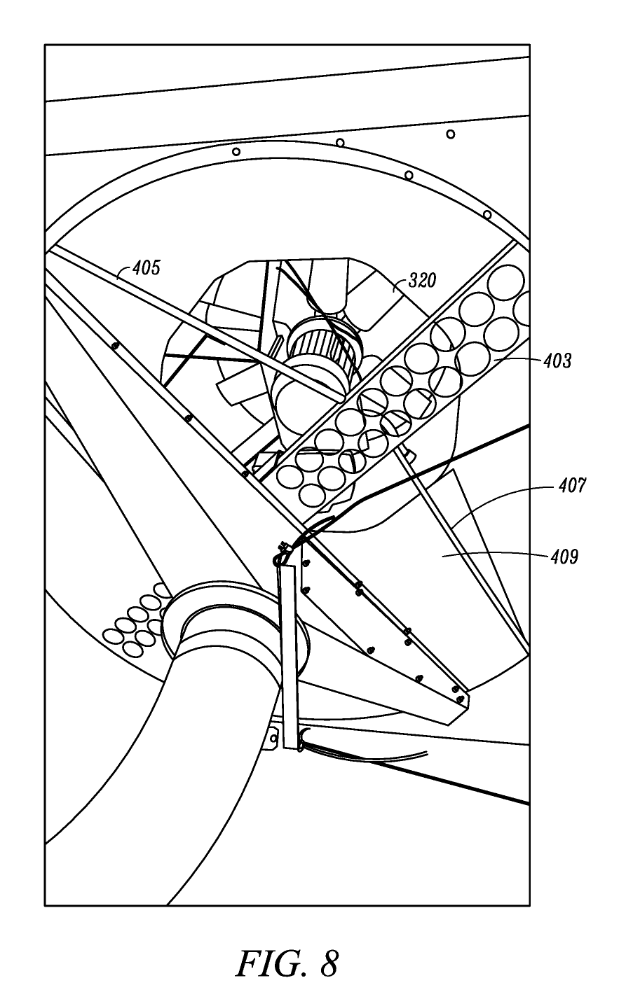

FIG. 8 is a view of a portion of the filtering apparatus 322 positioned near an exhaust fan 320 of a grain dryer, according to an example embodiment. FIG. 8 is a view from inside a grain dryer. The grain dryer filtering apparatus 322 shows the filter 400 and the material remover 500. The filter 400 includes a filter media 409 positioned near the inlet of the exhaust fan 320 of the dryer; a rotary head 500 having a first end 512 with an elongated nozzle positioned proximate the filter media 409, and a second end 514. The rotary head 510 is attached to a shaft 410. The grain dryer filtering apparatus 100 also includes a head mover or gearmotor 520 attached to the shaft 410 to rotate the nozzle or rotary head 510 over the filter media 409, and a vacuum source 341 fluidly coupled with the head 500. The vacuum source further includes a collection fan 341 in fluid communication with the head, a cyclonic separator 350 in fluid communication with the collection fan 341 and the head 510. The collection fan 341 in some embodiments is a collection fan. The grain dryer filtering apparatus 322 also includes a return path 144 to place air from the cyclonic separator in a plenum before the filter 400 and the exhaust opening of the dryer. The return path 144 includes the collection fan 141, 341 and the cyclonic separator 142, 350.

A grain dryer filtering apparatus 322 includes a filter 400 positioned near the inlet of the exhaust fan 320 of the dryer, and a nozzle 510 positioned near a portion of the filter 400. The grain dryer also includes a head mover 520 attached to the nozzle 510. The head mover 520 moves the nozzle 510 over other portions of the filter 400. A vacuum source 141,341 fluidly coupled with the head 510 and produces a vacuum at the nozzle 510 while it moves over the filter 400. In one embodiment, the filter is a filter media 409. The filter is a filter media 409 having openings therein for retaining material in the filter media before it exits the dryer. In one embodiment, the head mover 520 rotates the nozzle 510. In still another embodiment, the filter 400 is substantially circular in shape and the head 510 has a length about the same as the diameter of the circular filter. The elongated nozzle 512 also has a length about the same as the diameter of the circular filter. The head mover 520 rotates the elongated nozzle 512 to pass the nozzle in close proximity to the filter 400. The vacuum source 141, 341 is fluidly coupled to the head 510. The vacuum is sufficient to remove material from the filter 400. Debris and other material caught in the filter 400 and specifically the filter media 409 can be removed from the filter by the nozzle as the head mover 520 rotates the nozzle with its elongated nozzle 512 over the filter 400. In one embodiment, the head mover 520 includes a gearbox, and the head includes a shaft 410. One end of the shaft 410 is coupled to the gear box. The nozzle rotates over the filter 400 in response to the gearbox turning the shaft 410. In one embodiment, the vacuum source includes a collection fan 141, 341 in fluid communication with the head 510. In one embodiment, the vacuum source also includes a cyclonic separator 142, 350 in fluid communication with the collection fan 141, 341 and the head 510. The collection fan 141, 341 and the cyclonic separator 142, 350 can be ducted to one another and to the head. In yet another embodiment, a return path is used to place air from the cyclonic separator 142, 350 in a plenum near the exhaust fan 320. In one embodiment, the plenum is located adjacent the filter near the exhaust opening of the dryer.

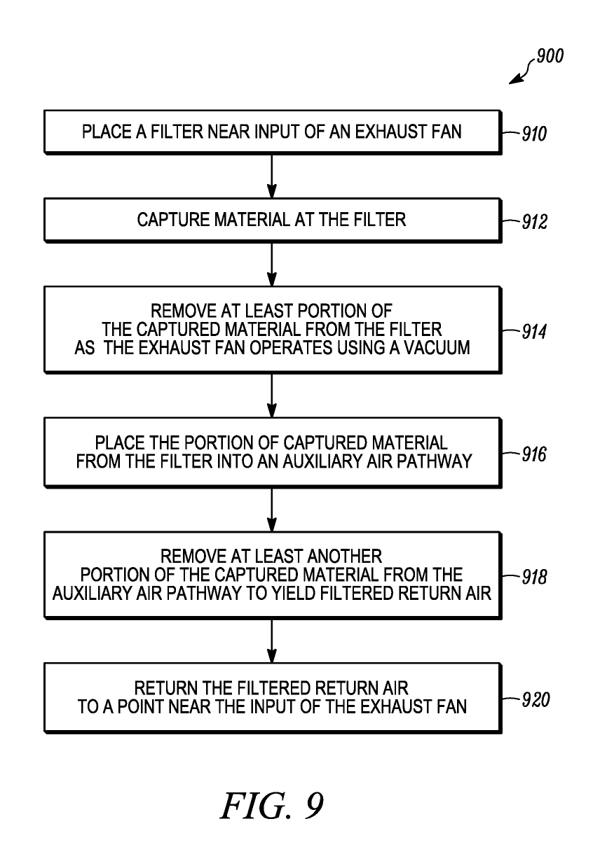

FIG. 9 is a flow diagram of a method 900 of filtering in a grain dryer, according to an example embodiment. The method 900 of filtering the exhaust from a grain dryer includes placing a filter near the input of an exhaust fan 910, capturing material at the filter 912, and removing at least a portion of the captured material from the filter as the exhaust fan operates using a vacuum 914. The method 900 also includes placing the portion of captured material from the filter into an auxiliary air pathway 916, and removing at least another portion of the captured material from the auxiliary air pathway to yield filtered return air 918. The method 900, in some embodiments, includes returning the filtered return air to a point near the input of the exhaust fan 920. The method 900 of filtering the exhaust from a grain dryer includes returning the filtered return air to a plenum near the input of the exhaust fan. In one embodiment, the element of removing at least another portion of the captured material from the auxiliary air 918 includes passing the air in the auxiliary pathway through a cyclonic separator. The at least another portion of the captured material from the auxiliary air can be placed back into the dry grain stream or can be discarded. The removed material can be heavy and these can be placed in with the dry grain to increase the weight of the grain. This is a profitable practice when the grain is sold by the pound or when bushels or some other measure is equated to weight.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed:

1. A grain dryer filtering apparatus comprising:
a filter positioned near the inlet of the exhaust fan of the dryer;
a nozzle positioned near a portion of the filter;
a head mover attached to the nozzle, the head mover for moving the nozzle over other portions of the filter; and
a vacuum source fluidly coupled with the head.

2. The grain dryer filtering apparatus of claim 1 wherein the filter filtering media.

3. The grain dryer filtering apparatus of claim 2 wherein the filter media has openings therein for retaining material in the filter media before it exits the dryer.

4. The grain dryer filtering apparatus of claim 1 wherein the head mover rotates the nozzle.

5. The grain dryer filtering apparatus of claim 1 wherein the filter is substantially circular in shape and the head has a length about the same as the diameter of the circular filter, wherein the head mover rotates the nozzle to pass the nozzle in close proximity to the filter.

6. The grain dryer filtering apparatus of claim 5 wherein the head mover rotates the nozzle.

7. The grain dryer filtering apparatus of claim 5 wherein the vacuum source is fluidly coupled to the head, the vacuum sufficient to remove material from the filter and the head mover rotates the nozzle over the filter.

8. The grain dryer filtering apparatus of claim 5 wherein the head mover includes a gearbox, and the head includes a shaft coupled to the gear box, the nozzle rotating over the filter in response to the gearbox turning the shaft.

9. The grain dryer filtering apparatus of claim 5 wherein the filter is a filter media, the vacuum source is fluidly coupled to the head, the vacuum sufficient to remove material from the filter and the head mover rotates the nozzle over the filter.

10. The grain dryer filtering apparatus of claim 1 wherein the vacuum source is fluidly coupled to the head, the vacuum source further comprising of a collection fan in fluid communication with the head.

11. The grain dryer filtering apparatus of claim 1 wherein the vacuum source is fluidly coupled to the head, the vacuum source further comprising:
a collection fan in fluid communication with the head; and
a cyclonic separator in fluid communication with the collection fan and the head.

12. The grain dryer filtering apparatus of claim 1 wherein the vacuum source is fluidly coupled to the head, the vacuum source further comprising
a collection fan in fluid communication with the head; and
a cyclonic separator in fluid communication with the collection fan and the head;
a return path to place air from the cyclonic separator in a plenum before the filter and the exhaust opening of the dryer. A grain dryer filtering apparatus comprising:
a filter media positioned near the inlet of the exhaust fan of the dryer;
a head having a first end with an elongated nozzle positioned proximate the filter media, and a second end that includes a shaft;
a head mover attached to the shaft to rotate the nozzle over the filter media; and
a vacuum source fluidly coupled with the head, further comprising:
a vacuum fan in fluid communication with the head; and
a cyclonic separator in fluid communication with the vacuum fan and the head;
a return path to place air from the cyclonic separator in a plenum before the filter and the exhaust opening of the dryer, the return path including the collection fan and the cyclonic separator.

14. A method of filtering the exhaust from a grain dryer comprising:
placing a filter near the input of an exhaust fan;
capturing material at the filter;
removing at least a portion of the captured material from the filter as the exhaust fan operates using vacuum;
placing the portion of captured material from the filter into an auxiliary air pathway; and
removing at least another portion of the captured material from the auxiliary air pathway to yield filtered return air.

15. The method of filtering the exhaust from a grain dryer of claim 15 further comprising returning the filtered return air to a point near the input of the exhaust fan.

16. The method of filtering the exhaust from a grain dryer of claim 15 further comprising returning the filtered return air to a plenum near the input of the exhaust fan.

17. The method of filtering the exhaust from a grain dryer of claim 15 further wherein removing at least another portion of the captured material from the auxiliary air includes passing the air in the auxiliary pathway through a cyclonic separator.

18. The method of filtering the exhaust from a grain dryer of claim 17 wherein the at least another portion of the captured material from the auxiliary air is placed into a dry grain stream.
